(19) United States
(12) Patent Application Publication
(10) Pub. No.: US 2024/0267283 A1
(43) Pub. Date: Aug. 8, 2024

(54) NETWORK MANAGEMENT APPARATUS, METHOD, AND PROGRAM

(71) Applicant: NIPPON TELEGRAPH AND TELEPHONE CORPORATION, Tokyo (JP)

(72) Inventors: Hiroaki MATSUBAYASHI, Musashino-shi, Tokyo (JP); Shunsuke KANAI, Musashino-shi, Tokyo (JP); Kenji MURASE, Musashino-shi, Tokyo (JP); Masataka SATO, Musashino-shi, Tokyo (JP); Kazuaki AKASHI, Musashino-shi, Tokyo (JP); Manami OGAWA, Musashino-shi, Tokyo (JP)

(73) Assignee: NIPPON TELEGRAPH AND TELEPHONE CORPORATION, Tokyo (JP)

(21) Appl. No.: 18/567,788

(22) PCT Filed: Jun. 10, 2021
(86) PCT No.: PCT/JP2021/022172

§ 371 Date: Dec. 7, 2023

(51) Int. Cl. H04L 41/0659; H04L 41/0686

(52) U.S. Cl. CPC H04L 41/0661; H04L 41/0686

(57) ABSTRACT

A network management device includes a priority calculation unit to apply, to a situation in which, when a failure in communication occurs in a plurality of buildings that houses a communication facility. When a condition in which the failure that occurred is assumed to be restored regarding a plurality of combinations of some buildings among the buildings in which the failure has occurred by performing restoration on the communication facility housed in the building is applied, the failure in communication continuously occurs in a building that houses a communication facility used for providing a predetermined type of communication service among the plurality of buildings, a policy that defines weighting corresponding to the situation and calculate, for each of the plurality of combinations, priority of a possible combination of buildings in which the failure that occurred is to be actually restored among the buildings in which the failure has occurred.

### TECHNICAL FIELD

An embodiment of the present invention relates to a network management device, method, and program.

### BACKGROUND ART

In a building that houses a communication facility to provide communication to the outside (hereinafter, referred to as a communication building), in a case where, for example, power supply from a power plant is interrupted due to occurrence of a disaster such as an earthquake or a typhoon and thus communication in the building is disconnected, an emergency power generator or the like operated by fuel and provided in the building is operated to restore power supply, thereby resuming provision of communication.

When the emergency power generator is operated for a long time and the fuel stored in the building is exhausted, the operation of the emergency power generator is stopped. Thus, power supply is interrupted again, thereby disconnecting the communication. Therefore, a telecommunications carrier delivers and supplies fuel to the communication building by a vehicle or the like.

The telecommunications carrier needs to deliver fuel to the communication building before the fuel is exhausted or to promptly deliver fuel to the communication building in which the fuel has been exhausted by using a fuel delivery vehicle so as to early resume provision of communication.

In order to reduce an influence of the communication disconnection as much as possible under a condition of limited fuel resources, the telecommunications carrier needs to select, in a short time, a building to be recovered serving as a fuel delivery destination from among a large number of communication buildings in which fuel has been exhausted among the communication buildings in which power supply has been stopped.

It is necessary to select the building to be recovered in accordance with various situations such as a disaster-stricken building, an influence on a communication network service spread from the building, a location, a fuel situation, and a traffic situation. For manual consideration, a lot of time and advanced skills (experience) are required.

A response to the disaster is urgent, and a frequency of occurrence thereof is low, and thus it is difficult to train skilled people. Therefore, there is a need for a technique of selecting a building to be recovered in view of a situation of the disaster and automatically determining a fuel delivery plan to the building in a short time.

For example, Patent Literature 1 discloses a technique of obtaining network configuration information and failure influence information, and, based on the failure influence information, the above delivery plan can be determined by evaluating a building to be preferentially recovered among the buildings with a weight and a flag.

### CITATION LIST

### Patent Literature

Patent Literature 1: JP 2020-65202 A

### SUMMARY OF INVENTION

### Technical Problem

However, in the above technique, in order to change the weight and the flag depending on the type of disaster such as a heavy rain or an earthquake and a disaster damage situation, a lot of time and advanced skills are required to perform manual consideration.

The present invention has been made in view of the above circumstances, and an object thereof is to provide a network management device, method, and program capable of appropriately specifying a target to be restored from a communication failure when the communication failure occurs in a network configuration.

### Solution to Problem

A network management device according to an aspect of the present invention includes a priority calculation unit configured to apply, to a situation in which, when a failure in communication occurs in a plurality of buildings that houses a communication facility and when a condition in which the failure that occurred is assumed to be restored in each building regarding a plurality of combinations of some buildings among the buildings in which the failure has occurred by performing a restoration work on the communication facility housed in the building is applied, the failure in communication continuously occurs in a building that houses a communication facility used for providing a predetermined type of communication service among the plurality of buildings, a policy that defines weighting corresponding to the situation and calculate, for each of the plurality of combinations, priority of a possible combination of buildings in which the failure that occurred is to be actually restored among the buildings in which the failure has occurred.

A network management method according to an aspect of the present invention includes applying, to a situation in which, when a failure in communication occurs in a plurality of buildings that houses a communication facility and when a condition in which the failure that occurred is assumed to be restored in each building regarding a plurality of combinations of some buildings among the buildings in which the failure has occurred by performing a restoration work on the communication facility housed in the building is applied, the failure in communication continuously occurs in a building that houses a communication facility used for providing a predetermined type of communication service among the plurality of buildings, a policy that defines weighting corresponding to the situation and calculating, for each of the plurality of combinations, priority of a possible combination of buildings in which the failure that occurred is to be actually restored among the buildings in which the failure has occurred.

### Advantageous Effects of Invention

The present invention can appropriately specify a target to be restored from a communication failure when the communication failure occurs in a network configuration.

### BRIEF DESCRIPTION OF DRAWINGS

FIG. 1 illustrates an application example of a network management device according to an embodiment of the present invention.

FIG. 2 is a flowchart showing an example of a processing procedure by a network management device according to an embodiment of the present invention.

FIG. 3 illustrates an example of a function of a priority calculation unit.

FIG. 4 illustrates an example of types of communication services according to various policies.

FIG. 5 illustrates an example of buildings in which a communication failure occurs.

FIG. 6 is a table showing an example of the number of buildings in which a communication failure continuously occurs under a condition that a restoration work has been performed on a combination of buildings serving as a target of the restoration work and the number of users affected by the failure.

FIG. 7 illustrates an example of priority scores calculated by applying a first policy under a condition that a restoration work has been performed on a combination of buildings serving as a target of the restoration work.

FIG. 8 illustrates an example of weighting obtained by applying a first policy under a condition that a restoration work has been performed on a first combination of buildings serving as a target of the restoration work.

FIG. 9 illustrates an example of weighting obtained by applying a first policy under a condition that a restoration work has been performed on a second combination of buildings serving as a target of the restoration work.

FIG. 10 illustrates an example of priority scores calculated by applying a second policy under a condition that a restoration work has been performed on a combination of buildings serving as a target of the restoration work.

FIG. 11 illustrates an example of weighting obtained by applying a second policy under a condition that a restoration work has been performed on a first combination of buildings serving as a target of the restoration work.

FIG. 12 illustrates an example of weighting obtained by applying a second policy under a condition that a restoration work has been performed on a second combination of buildings serving as a target of the restoration work.

FIG. 13 illustrates an example of priority scores calculated by sequentially applying a first policy and a second policy under a condition that a restoration work has been performed on a combination of buildings serving as a target of the restoration work.

FIG. 14 illustrates an example of priority scores calculated by sequentially applying a second policy and a first policy under a condition that a restoration work has been performed on a combination of buildings serving as a target of the restoration work.

FIG. 15 is a block diagram illustrating an example of a hardware configuration of a network management device according to an embodiment of the present invention.

### DESCRIPTION OF EMBODIMENTS

Hereinafter, an embodiment according to the present invention will be described with reference to the drawings.

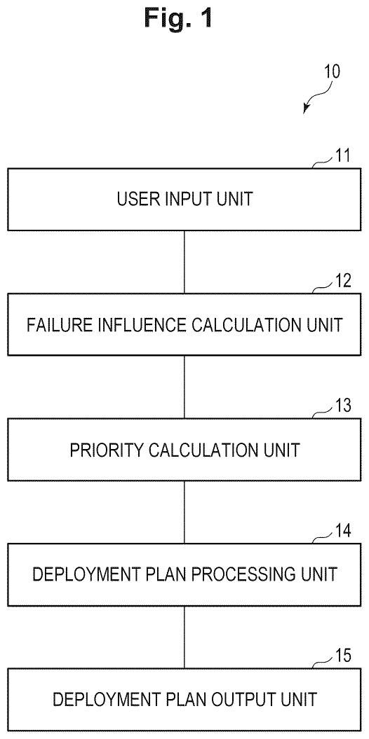

FIG. 1 illustrates an application example of a network management device according to the embodiment of the present invention.

As illustrated in FIG. 1, a network management device 10 according to the embodiment of the present invention includes a user input unit 11, a failure influence calculation unit 12, a priority calculation unit 13, a deployment plan processing unit 14, and a deployment plan output unit 15.

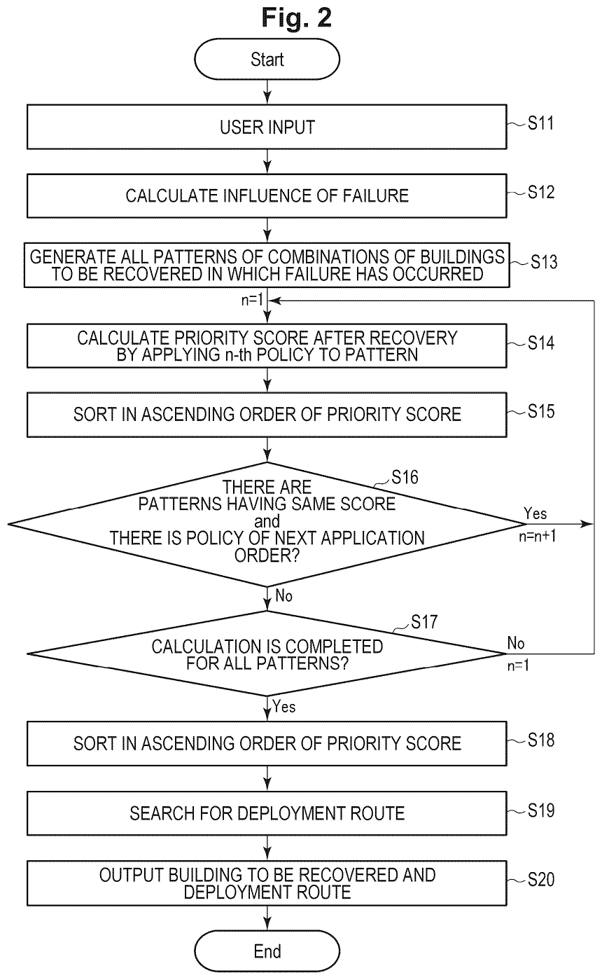

FIG. 2 is a flowchart showing an example of a processing procedure by the network management device according to the embodiment of the present invention.

The user input unit 11 inputs failure information and vehicle deployment information (S11). The failure information indicates a communication failure occurring in any of a plurality of buildings that houses a communication device and forms a network configuration, for example, a network redundancy configuration. The vehicle deployment information relates to a power supply situation regarding restoration from the communication failure that occurred and a restoration work vehicle deployed for restoring the communication failure.

The power supply situation is, for example, an amount of fuel with which an emergency power generator (described later) housed in each building needs to be replenished and an elapsed time from the occurrence of the communication failure in each building. The vehicle deployment information is, for example, a current position of the restoration work vehicle, the number of restoration work vehicles movable to buildings, and an amount of fuel transportable and suppliable by each restoration work vehicle.

Based on the failure information input in S11, the failure influence calculation unit 12 calculates an influence of the communication failure that has occurred due to a stop of power supply to the communication facilities housed in some buildings in the network configuration on other buildings in the same network configuration (S12).

Under a condition that the failure indicated by the failure information input in S11 and the calculation result in S12 are applied, the priority calculation unit 13 generates all patterns of combinations of buildings to be recovered, i.e., to be restored from the communication failure among combinations of buildings in which the communication failure has occurred (S13). The patterns will also be referred to as patterns of buildings to be recovered or recovery target patterns.

For each of the generated patterns, the priority calculation unit 13 applies an n-th policy corresponding to a predetermined type of communication service, here, a first policy (n=1) having a higher application order between the first policy and a second policy to the communication failure and an influence thereof, the communication failure continuously occurring in a building that houses a communication facility used for providing the predetermined type of communication service among the buildings in which the communication failure has occurred under a condition that buildings corresponding to the pattern are assumed to have been recovered, for example, under a condition that power supply to the communication facilities housed in the buildings are assumed to have been restored, that is, to a situation of the continuously occurring communication failure. By this application, the priority calculation unit 13 calculates a priority score (hereinafter, also simply referred to as priority) according to weighting corresponding to the communication failure continuously occurring in any building (S14). The policy to be applied can be arbitrarily set by a user operating the user input unit 11.

When calculating the priority score for a plurality of patterns in S14, the priority calculation unit 13 sorts the above patterns in ascending order of the priority score that is a calculation result, that is, in ascending order of the communication failure and the influence thereof, the communication failure continuously occurring after the assumed restoration is performed (S15).

As a result of the sorting in S15, in a case where there is a plurality of patterns having the same calculated priority score among the plurality of patterns and there is a policy of the next application order, for example, the second policy, before the policy is applied (Yes in S16), the priority calculation unit 13 applies, for those patterns, the policy of the next application order (n=n+1) to the situation of the communication failure continuously occurring in a building that houses a communication facility used for providing a type of communication service regarding the policy of the next application order among the buildings in which the communication failure has occurred under a condition that the buildings corresponding to the patterns are assumed to have been recovered. Then, the processing of calculating the priority score in S14 and the subsequent processing are performed. In this case, the priority scores calculated according to the policies applied to the same pattern are summed.

Meanwhile, in a case of No in S16, when the calculation of the priority score in S14 has not been completed for all the patterns (No in S17), the priority calculation unit 13 applies, for a corresponding pattern, the first policy (n=1) to the situation of the communication failure continuously occurring in a building that houses a communication facility used for providing a type of communication service corresponding to the first policy among the buildings in which the communication failure has occurred under a condition that the buildings corresponding to the pattern are assumed to have been recovered. Then, the processing of calculating the priority score in S14 and the subsequent processing are performed for the pattern.

When the calculation in S14 is completed for all the patterns (Yes in S17), the priority calculation unit 13 extracts, for each pattern, the priority score calculated in S14 according to the applied policy and generates information in which the patterns are sorted in ascending order of the priority score, that is, in descending order of effect when the assumed restoration is actually performed, such that priority of a possible building to be actually restored from the failure that occurred is set to be high (S18).

The deployment plan processing unit 14 prioritizes a pattern to which a high priority score is set in the sorted patterns and searches for an appropriate deployment route of a restoration work vehicle to each building in the pattern according to the priority score on the basis of the power supply situation and the vehicle deployment information input in S11 (S19).

Upon receiving a processing result in S19, the deployment plan output unit 15 outputs a name of the building to be recovered and information indicating a deployment route, that is, a movement route of the restoration work vehicle to the corresponding building (S20).

Details of each process will be described below. Regarding buildings for which communication is provided and which form a redundancy configuration of a communication network, the user input unit 11 inputs a connection relationship between the buildings in the network redundancy configuration, the type of emergency power supply in each building, a location of each building, information indicating an influence when a communication failure occurs in the building, an elapsed time from occurrence of a communication failure in the building, and the like in response to an input operation or the like from an operator or the like.

The provision of communication in the building means, for example, communication between communication devices in the building and communication between a communication device in the building and an external communication device.

Examples of the communication failure include disconnection of communication caused by interruption of power supply to the communication device in the building and disconnection of communication caused by failure of a communication facility such as a server or damage to a communication cable. In the following description of the present embodiment, disconnection of communication caused by interruption of power supply to the communication device in the building will be described as an example.

Examples of the type of emergency power supply in each building include an emergency power generator operated by fuel and an emergency power supply device operated by a chargeable and dischargeable storage battery. The emergency power generator is, for example, a diesel engine.

Note that the above building may have another form as long as the building is a facility for which communication is provided.

The connection relationship between the buildings may include, for example, information indicating an upper layer (hereinafter, also simply referred to as upper) and a lower layer (hereinafter, also simply referred to lower) in a network topology.

Regarding vehicles for a communication restoration work (hereinafter, also referred to as restoration work vehicles) for the buildings in which the communication failure has occurred, the user input unit 11 further inputs the number of vehicles, the type of vehicle, position information of each vehicle, an amount of fuel for an emergency power generator or the like that can be supplied from each vehicle, a traffic situation of a traveling area of each vehicle, and the like in response to the above input operation or the like. Examples of the traffic situation include information indicating a volume of traffic in the traveling area and information indicating whether or not a road is passable based on construction or disaster.

Examples of the type of vehicle include a fuel delivery vehicle and a power supply vehicle.

The fuel delivery vehicle is loaded with fuel for the emergency power generator when the emergency power supply in the building is the emergency power generator and includes a facility that fills the emergency power generator with the fuel.

The power supply vehicle has a function of charging the storage battery when the emergency power supply in the building is the emergency power supply device or is loaded with a storage battery for replacement, that is, a new charged storage battery when the storage battery is replaceable.

Based on the information input by the user input unit 11, the failure influence calculation unit 12 specifies, as a target to be affected by the failure, a plurality of lower buildings in the network topology in which communication is disconnected due to an influence of the occurrence of the communication failure in a plurality of upper buildings in the network topology among the buildings in the network redundancy configuration.

A technique of specifying a facility in which communication is disconnected due to the above influence is a known technique disclosed in, for example, Patent Literature 1.

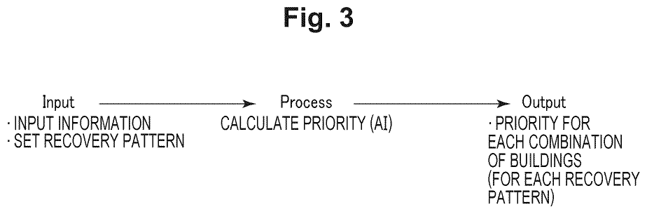

FIG. 3 illustrates an example of a function of the priority calculation unit.

The priority calculation unit 13 applies a policy by using, for example, artificial intelligence (AI) on the basis of various types of information such as the failure information input by the user input unit 11 and each generated pattern of the combination of the buildings to be restored from the communication failure, performs weighting corresponding to the communication failure that continuously occurs under a condition that restoration is assumed to have been performed, and thus obtains a priority score for each combination of the buildings.

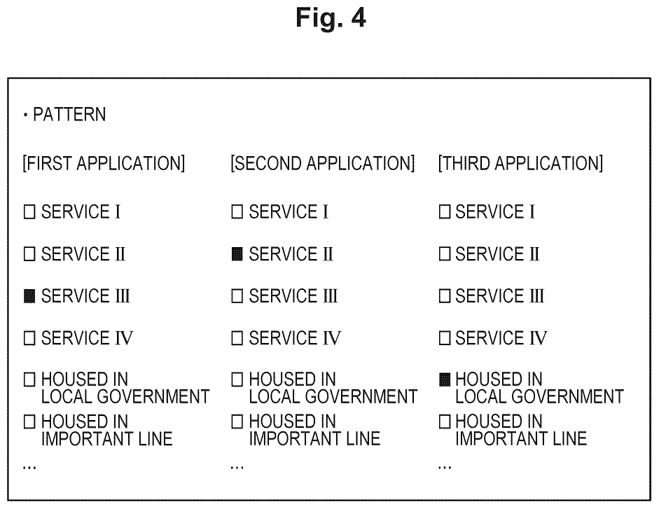

FIG. 4 illustrates an example of types of communication services according to various policies.

The example of FIG. 4 shows types of communication services for which a priority score is to be calculated regarding a policy of a first application order, a policy of a second application order, and a policy of a third application order.

The example of FIG. 4 shows that, when the policy of the first application order is applied, a priority score regarding a recovery target pattern to which the policy is applied is calculated according to the communication failure that continuously occurs in provision of a communication service whose type is a “service III” under a condition that a restoration work is assumed to have been performed on buildings regarding the pattern of buildings to be recovered to which the policy is applied.

The example of FIG. 4 shows that, when the policy of the second application order is applied, a priority score regarding a recovery target pattern to which the policy is applied is calculated according to a communication failure that continuously occurs in provision of a communication service whose type is a “service II” under a condition that a restoration work is assumed to have been performed on buildings regarding the recovery target pattern to which the policy is applied.

The example of FIG. 4 shows that, when the policy of the third application order is applied, a priority score regarding a recovery target pattern to which the policy is applied is calculated according to a communication failure that continuously occurs in provision of a communication service whose type is “housed in local government” under a condition that a restoration work is assumed to have been performed on buildings regarding the recovery target pattern to which the policy is applied.

For example, in a case where the priority score regarding the first recovery target pattern, which is calculated by applying the policy of the first application order to the situation of the continuously occurring communication failure, is the same as the priority score regarding the second recovery target pattern, which is calculated by applying the same policy of the first application order to the situation of the continuously occurring communication failure, the policy of the second application order after the first application order is applied only to the above two recovery target patterns, and then the priority scores are calculated again. In a case where the priority scores are different from each other, the calculation of the priority scores regarding the above patterns is terminated.

The communication services regarding those policies may be arbitrarily replaced according to a situation of a disaster, for example. Therefore, the application order of the policy for each communication service can be changed. Thus, for example, it is possible to flexibly set a destination where a restoration work is performed in accordance with a communication service that can be performed or needs to be preferentially performed according to a change in the situation of the disaster.

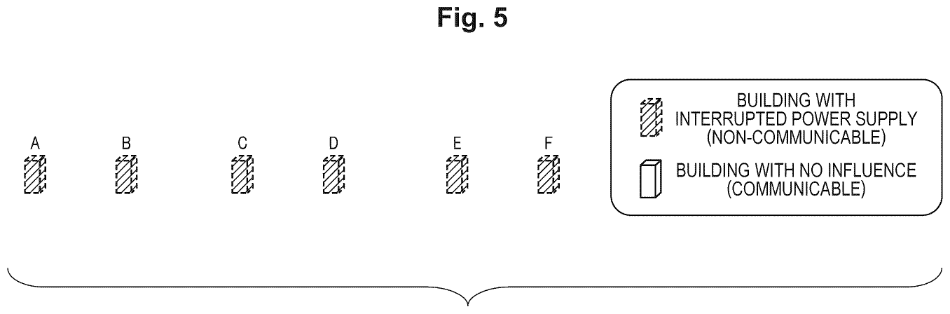

FIG. 5 illustrates an example of buildings in which a communication failure occurs.

In the example of FIG. 5, the buildings in which a communication failure occurs are a “building A”, a “building B”, a “building C”, a “building D”, a “building E”, and a “building F”. In the present embodiment, combination patterns of some or all of the buildings are set as a target of a restoration work for the communication failure.

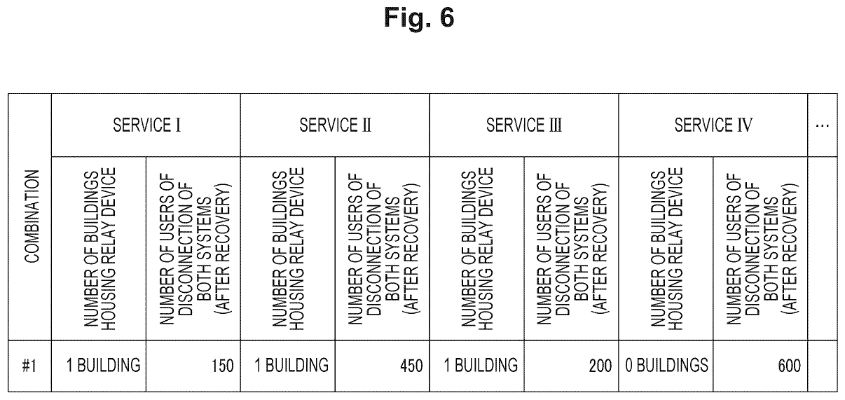

FIG. 6 is a table showing an example of the number of buildings in which a communication failure continuously occurs under a condition that a restoration work has been performed on a combination of buildings serving as a target of the restoration work and the number of users affected by the failure.

In the example of FIG. 6, a pattern “#1” of the building to be recovered, here, a combination of the “building C” and the “building F” is a target pattern of the restoration work, and the example shows that, under a condition that the restoration work for the buildings is assumed to have been performed, the number of buildings housing a relay device continuously affected by the communication failure among relay devices used for providing a communication service whose type is a “service I” (hereinafter, also simply referred to as the “service I”) is 1, and the number of users affected by disconnection of both the systems caused by the failure among users of the “service I” is 150.

The example of FIG. 6 shows that, under the above assumed condition, the number of buildings housing a relay device continuously affected by the communication failure among relay devices used for providing a communication service whose type is the “service II” (hereinafter, also simply referred to as “service II”) is 1, and the number of users affected by the disconnection of both the systems caused by the failure among users of the “service II” is 450.

The example of FIG. 6 shows that, under the above assumed condition, the number of buildings housing a relay device continuously affected by the communication failure among relay devices used for providing a communication service whose type is the “service III” (hereinafter, also simply referred to as “service III”) is 1, and the number of users affected by the disconnection of both the systems caused by the failure among users of the “service III” is 200.

The example of FIG. 6 shows that, under the above assumed condition, the number of buildings housing a relay device continuously affected by the communication failure among relay devices used for providing a communication service whose type is “service IV” (hereinafter, also simply referred to as “service IV”) is 0, and the number of users affected by the disconnection of both the systems caused by the failure among users of the “service IV” is 600.

In a general technique, a combination of buildings on which a restoration work is preferentially performed is selected in consideration of various matters such as “If the service II is not recovered, many customers will be inconvenienced.”, “In order to minimize an influence on the service II while maintaining provision of the service III, how should parameters be given?”, and “The service III is applied to an important system of a local government.” in accordance with the situation of the communication failure. This requires a large operation load and many skills.

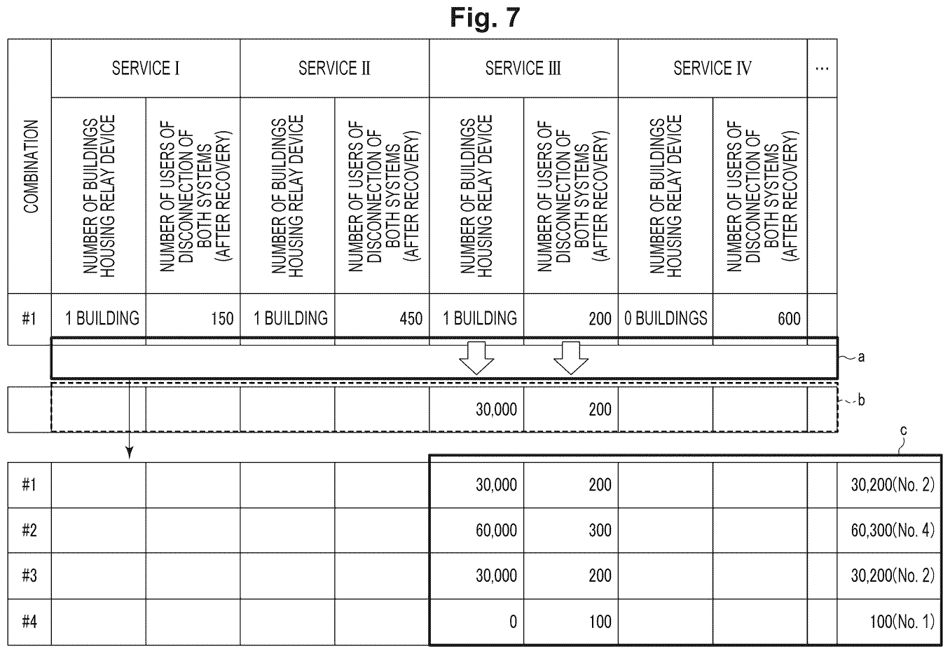

Next, an example of calculating priority of a building to be recovered when the “service III” is preferentially provided will be described. FIG. 7 illustrates an example of a priority score calculated by applying the first policy under a condition that a restoration work has been performed on a combination of buildings serving as a target of the restoration work.

The priority score regarding the building to be recovered is calculated by performing weighting corresponding to the situation of the continuously occurring communication failure under a condition that the restoration work is assumed to have been performed on buildings to be recovered for each possible combination of the buildings to be recovered.

In the example of FIG. 7, a rule of weighting serving as a penalty corresponding to the number of buildings that are not recovered under a condition that the restoration work is assumed to have been performed on the buildings to be recovered, that is, the number of buildings in which the communication failure continuously occurs under the above condition, among the buildings housing the relay device used for providing the “service III” (hereinafter, also referred to as “service III relay buildings”) and a rule of weighting corresponding to the number of users housed in the buildings that are not recovered, that is, the number of users of the disconnection of both the systems (hereinafter, referred to as the “number of service-III-affected users”) affected by the continuously occurring communication failure are set in advance as a “service III priority policy” and are stored in a storage device of the network management device 10.

In the example of FIG. 7, when the “service III priority policy” is applied (see a reference sign a in FIG. 7) to a situation in which, under a condition that an identification number is “#1” when a possible combination of buildings to be recovered is the buildings C and F in FIG. 6 and a restoration work is assumed to have been performed on the combination, the “service III relay building” in which the communication failure regarding the “service III” continuously occurs is present among the buildings of FIG. 6, a score “30,000” to be added for each building is calculated. Here, because the number of “service III relay buildings” in which the communication failure continuously occurs is “1”, the additional score “30,000” regarding the number of buildings in which the communication failure continuously occurs is calculated (see a reference sign b in FIG. 7).

Further, when the “service III priority policy” is applied (see the reference sign a in FIG. 7) to the situation in which the communication failure regarding the “service III” continuously occurs under a condition that the restoration work is assumed to have been performed on the combination of the identification number “#1”, the number of users of the disconnection of both the systems affected by the continuously occurring communication failure among the users housed in each building of FIG. 6, here, the number of users housed in the “service III relay building” in which the communication failure occurs (“the number of service-III-affected users”), which is “200”, is further calculated as an additional score regarding the number of affected users (see the reference sign b in FIG. 7).

Then, a score of recovery priority, which is priority when the possible combination of the buildings to be recovered is set as an actual target of the restoration work, is the sum of the score calculated as the penalty and the score calculated as the number of service-III-affected users. As the priority score is smaller, the priority of the actual restoration work is higher. In the example of FIG. 7, “30,200”, which is the sum of the score “30,000” regarding the penalty when a possible combination for the restoration work is the buildings C and F and the score “200” regarding the “number of service-III-affected users”, is calculated as the priority score when the restoration work is actually performed on the possible combination for the restoration work when the possible combination is the buildings C and F (see a reference sign c in FIG. 7).

Then, also for each of the other possible combinations of the buildings for the restoration work, here, for each of the possible combinations of the buildings for the restoration work whose identification numbers are “#2” to “#4”, the “service III priority policy” is applied to the number of buildings in which the failure continuously occurs under a condition that the restoration work is performed on the buildings of the combination and to the “number of service-III-affected users”, and thus the priority score is calculated.

In the example of FIG. 7, “60, 300” is calculated as the priority score for the possible combination of the buildings for the restoration work whose identification number is “#2”, “30, 200” is calculated as the priority score for the possible combination of the buildings for the restoration work whose identification number is “#3”, and “100” is calculated as the priority score for the possible combination of the buildings for the restoration work whose identification number is “#4” (see the reference sign c in FIG. 7).

Then, the combinations are sorted in order of the priority score calculated for each combination, and the identification number of a combination having the smallest priority score, that is, the identification number of a combination having the lowest priority of the actual restoration work is specified to be “#4”.

The identification numbers of combinations having the second smallest priority score are “#1” and “#3”, and the identification number of a combination having the largest priority score, that is, the identification number of a combination having the highest priority of the actual restoration work is “#2”.

As described above, when the communication failure occurs in the buildings A to F of FIG. 6, a combination of buildings having the highest priority as buildings on which the restoration work is actually performed with priority to the “service III” is the combination of the buildings having the identification number “#4”.

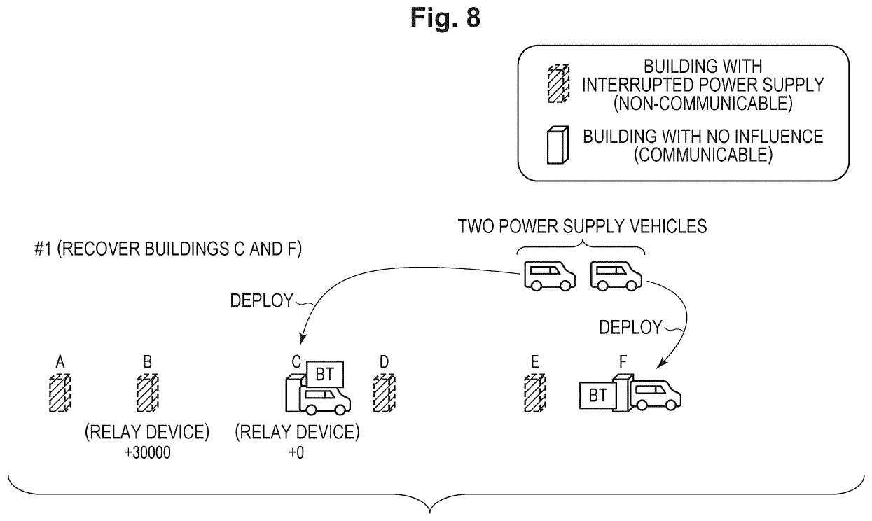

FIG. 8 illustrates an example of weighting obtained by applying the first policy under a condition that a restoration work has been performed on a first combination of buildings serving as a target of the restoration work.

In the example of FIG. 8, the communication failure occurs in the buildings A to F of FIG. 6, and, among the buildings, the buildings B and C are the “service III relay buildings” housing the relay device used for the “service III”.

Then, under a condition that restoration work vehicles, here, two power supply vehicles are deployed to the buildings C and F regarding the identification number “#1” of the combination of the buildings for the restoration work and thus the communication failure in the buildings is assumed to be restored, the communication failure continuously occurs in the building B among the “service III relay buildings”. Thus, the example shows that “30,000”, which is weighting regarding the identification number “#1”, is set as the penalty.

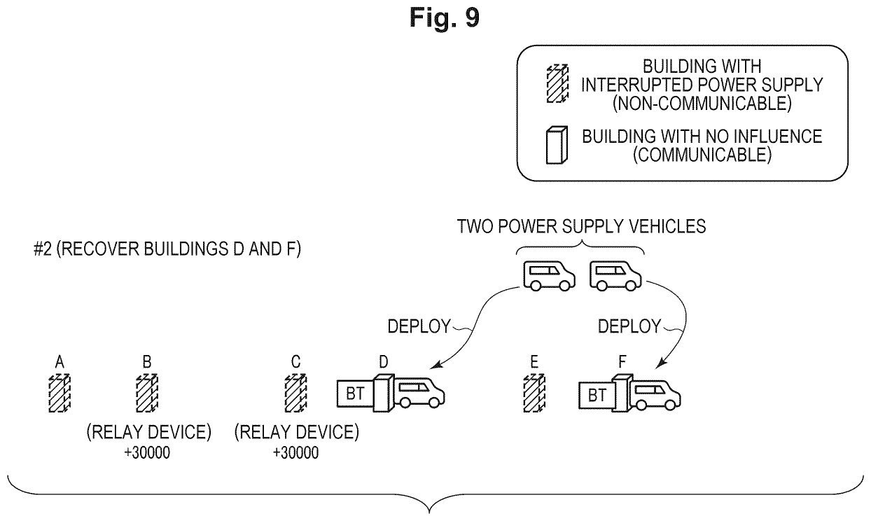

FIG. 9 illustrates an example of weighting obtained by applying the first policy under a condition that a restoration work has been performed on a second combination of buildings serving as a target of the restoration work.

In the example of FIG. 9, the communication failure occurs in the buildings A to F of FIG. 6, and, among the buildings, the buildings B and C are the “service III relay buildings”.

Then, under a condition that restoration work vehicles, here, two power supply vehicles are deployed to the buildings D and F regarding the identification number “#2” of the combination of the buildings for the restoration work and thus the communication failure in the buildings is assumed to be restored, the communication failure continuously occurs in the buildings B and C among the “service III relay buildings”. Thus, the example shows that “60,000”, which is weighting regarding the identification number “#2”, is set as the penalty.

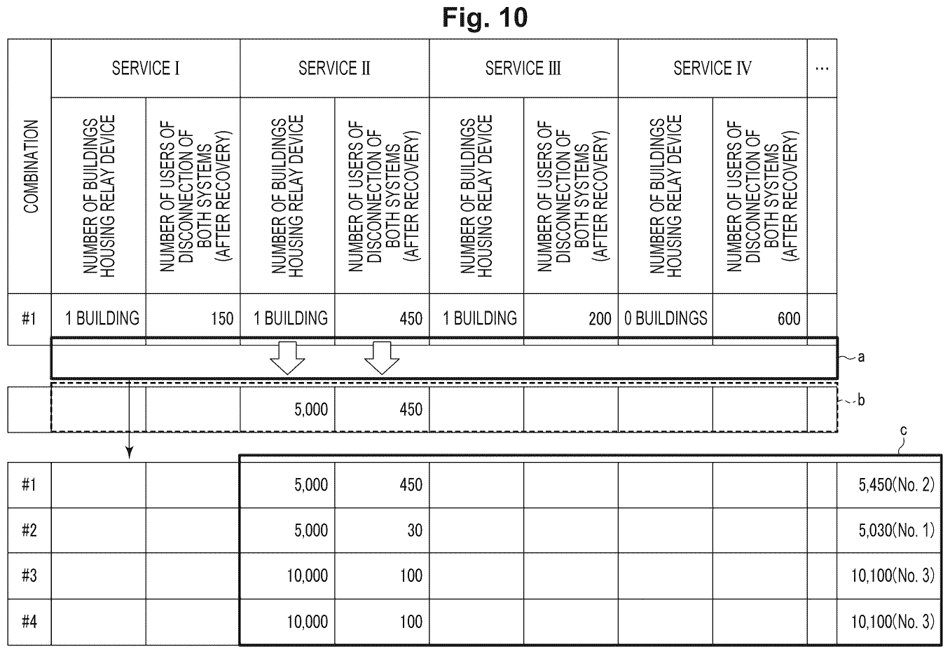

Next, an example of calculating priority of a building to be recovered when the “service II” is preferentially provided will be described. FIG. 10 illustrates an example of priority scores calculated by applying the second policy under a condition that a restoration work has been performed on a combination of buildings serving as a target of the restoration work.

In the example of FIG. 10, a rule of weighting serving as a penalty corresponding to the number of buildings that are not recovered under a condition that the restoration work is assumed to have been performed on the buildings to be recovered, that is, the number of buildings in which the communication failure continuously occurs under the above condition, among the buildings housing the relay device used for providing the “service II” (hereinafter, also referred to as “service II relay buildings”) and a rule of weighting corresponding to the number of users housed in the buildings that are not recovered, that is, the number of users of the disconnection of both the systems (hereinafter, referred to as the “number of service-II-affected users”) affected by the continuously occurring communication failure are set in advance as a “service II priority policy” and are stored in the storage device of the network management device 10.

In the example of FIG. 10, when the “service II priority policy” is applied (see a reference sign a in FIG. 10) to a situation in which, under a condition that the identification number is “#1” when a possible combination of buildings to be recovered is the buildings C and F in FIG. 6 and a restoration work is assumed to have been performed on the combination, the “service II relay building” in which the communication failure regarding the “service II” continuously occurs is present among the buildings of FIG. 6, the additional score “5,000” for each building is calculated. Here, because the number of “service II relay buildings” in which the communication failure continuously occurs is “1”, the additional score “5,000” regarding the number of buildings in which the communication failure continuously occurs is calculated (see a reference sign b in FIG. 10).

Further, when the “service II priority policy” is applied (see the reference sign a in FIG. 10) to the situation in which the “service II relay building” in which the communication failure regarding the “service II” continuously occurs is present under a condition that the restoration work is assumed to have been performed on the combination of the identification number “#1”, the number of users of the disconnection of both the systems affected by the continuously occurring communication failure among the users housed in each building of FIG. 6, here, the number of users housed in the “service II relay building” in which the communication failure occurs (“the number of service-II-affected users”), which is “450”, is further calculated as an additional score regarding the number of affected users (see the reference sign b in FIG. 10).

Then, the score of the recovery priority is the sum of the score calculated as the penalty and the score calculated as the “number of service-II-affected users”. In the example of FIG. 10, “5,450”, which is the sum of the score “5,000” serving as the penalty when the possible combination for the restoration work is the buildings C and F and the score “450” regarding the “number of service-II-affected users”, is calculated as the priority score when the restoration work is actually performed on the possible combination for the restoration work when the possible combination is the buildings C and F (see a reference sign c in FIG. 10).

Then, also for each of the other possible combinations of the buildings for the restoration work, here, for each of the possible combinations of the buildings for the restoration work whose identification numbers are “#2” to “#4”, the “service II priority policy” is applied to the number of buildings in which the failure continuously occurs under a condition that the restoration work is performed on the buildings of the combination and to the “number of service-II-affected users”, and thus the priority score is calculated.

In the example of FIG. 10, “5,030” is calculated as the priority score for the possible combination of the buildings for the restoration work whose identification number is “#2”, and “10,100” is calculated as the priority scores for the possible combinations of the buildings of the restoration work whose identification numbers are “#3” and “#4” (see the reference sign c in FIG. 10).

Then, the combinations are sorted in order of the priority score calculated for each combination, and the identification number of a combination having the smallest priority score, that is, the identification number of a combination having the lowest priority of the actual restoration work is specified to be “#2”.

The identification number of a combination having the second smallest priority score is “#1”, and the identification numbers of combinations having the largest priority score, that is, the identification numbers of combinations having the highest priority of the actual restoration work are “#3” and “#4”.

As described above, when the communication failure occurs in the buildings A to F of FIG. 6, a combination of buildings having the highest priority as buildings on which the restoration work is actually performed with priority to the “service II” is the combination of the buildings having the identification number “#2”.

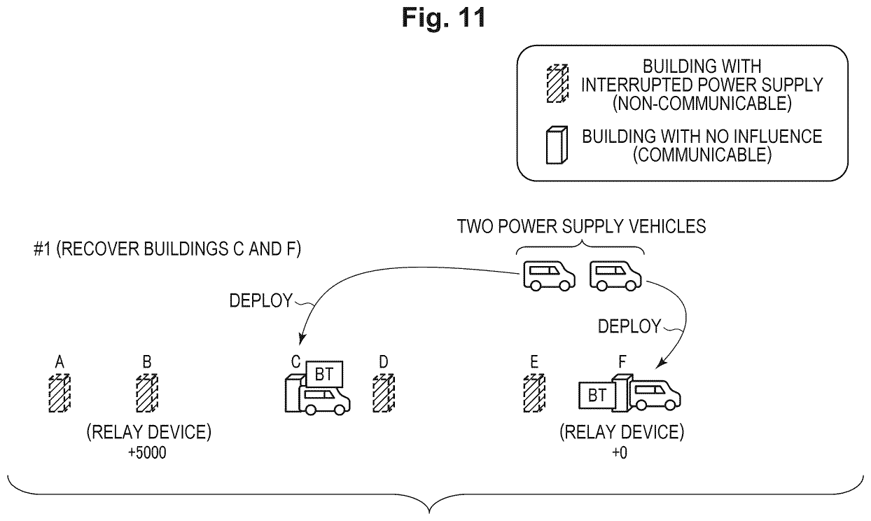

FIG. 11 illustrates an example of weighting obtained by applying the second policy under a condition that a restoration work has been performed on the first combination of buildings serving as a target of the restoration work.

In the example of FIG. 11, the communication failure occurs in the buildings A to F of FIG. 6, and, among the buildings, the buildings B and F are the “service II relay buildings” housing the relay device of the “service II”.

Then, under a condition that restoration work vehicles, here, two power supply vehicles are deployed to the buildings C and F regarding the identification number “#1” of the combination of the buildings for the restoration work and thus the communication failure in the buildings is assumed to be restored, the communication failure continuously occurs in the building B among the “service II relay buildings”. Thus, the example shows that “5,000”, which is weighting regarding the identification number “#1”, is set as the penalty.

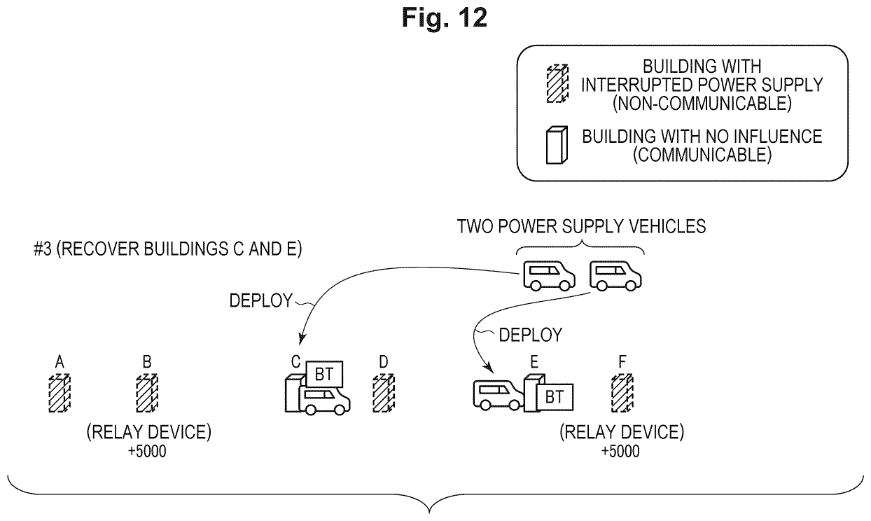

FIG. 12 illustrates an example of weighting obtained by applying the second policy under a condition that a restoration work has been performed on the second combination of buildings serving as a target of the restoration work.

In the example of FIG. 12, the communication failure occurs in the buildings A to F of FIG. 6, and, among the buildings, the buildings B and F are the “service II relay buildings”.

Then, under a condition that restoration work vehicles, here, two power supply vehicles are deployed to the buildings C and E regarding the identification number “#3” of the combination of the buildings for the restoration work and thus the communication failure in the buildings is assumed to be restored, the communication failure continuously occurs in both the buildings B and F among the “service II relay buildings”. Thus, the example shows that “10,000”, which is weighting regarding the identification number “#3”, is set as the penalty.

Next, calculation of priority scores when a policy of the weighting regarding a first type of communication service and a policy of the weighting regarding a second type of communication service are applied in order of application will be described.

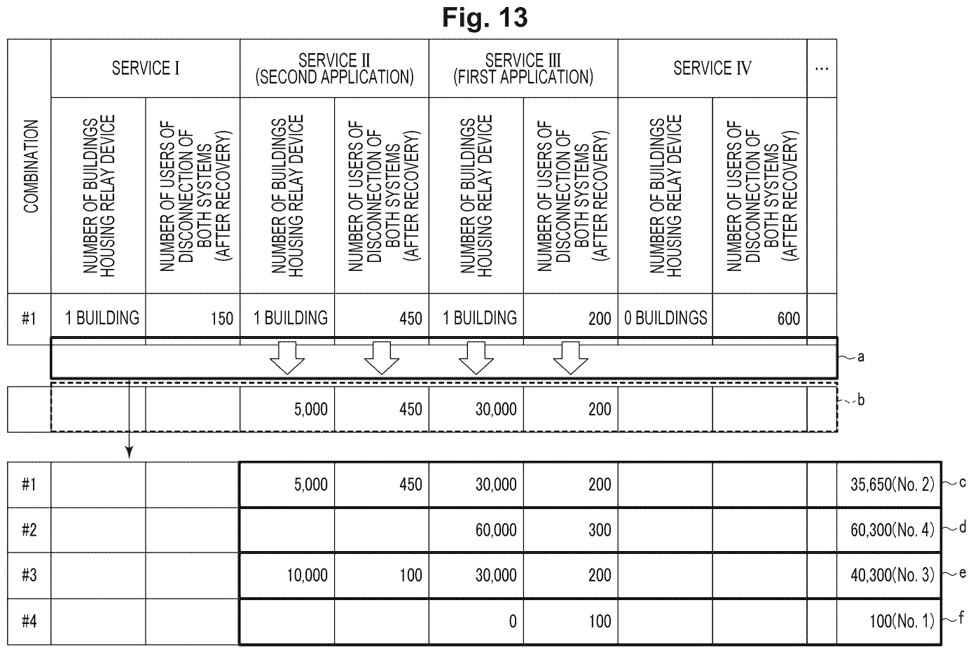

FIG. 13 illustrates an example of scores calculated by sequentially applying the first policy and the second policy under a condition that a restoration work has been performed on a combination of buildings serving as a target of the restoration work.

In the example of FIG. 13, the “service III priority policy” described with reference to FIG. 7 is applied as a first application order to the situation in which the “service III relay building” in which the communication failure regarding the “service III” occurs is present (see a reference sign a in FIG. 13). Then, when priority scores calculated by applying the “service III priority policy” are the same in some of the patterns of the combinations, the “service II priority policy” is applied only for this pattern as a second application order to the situation in which the “service II relay building” in which the communication failure regarding the “service II” continuously occurs is present (see the reference sign a in FIG. 13). Then, the priority scores calculated by the above application are calculated as additional values of the priority scores regarding the corresponding patterns (see a reference sign b in FIG. 13). This improves clarity of the priority of the restoration work when the patterns are sorted.

Specifically, for each of the combinations “#1” and “#4” of the buildings to be recovered in FIG. 7, the “service III priority policy” is applied as the first application order to the situation in which the “service III relay building” in which the communication failure regarding the “service III” occurs is present, and thus priority scores similar to those in the example of FIG. 7 are calculated (see reference signs c to f in FIG. 13).

As a result of sorting the combinations in order of the priority score calculated for each combination, as illustrated in FIG. 7, the priority scores, which are obtained by adding the score regarding the penalty and the score regarding the users of both the systems calculated for each of the combinations “#1” and “#3” of the buildings to be recovered, are the same “30,200” (see the reference signs c and e in FIG. 13).

In view of this, for each of the combinations “#1” and “#3”, a priority score is calculated by applying the “service II priority policy” as the second application order to the situation in which the “service II relay building” in which the communication failure regarding the “service II” occurs is present.

As a result of the calculation, as illustrated in FIG. 13, the additional value of the priority score, which is obtained by adding the score regarding the penalty and the score regarding the users of both the systems calculated for the possible combination “#1” of the buildings to be recovered, is “5,450” (see the reference sign c in FIG. 13). Further, the additional value of the priority score, which is obtained by adding the score regarding the penalty and the score regarding the users of both the systems calculated for the possible combination “#3” of the buildings to be recovered, is “10,100” (see the reference sign e in FIG. 13).

As a result of the calculation of the above additional values, the priority score calculated for the possible combination “#1” of the buildings to be recovered is updated to “35,650” by adding the score “5,450” calculated when the “service II priority policy” is applied as the second application order to the score “30,200” calculated when the “service III priority policy” is applied as the first application order (see the reference sign c in FIG. 13).

As a result of the calculation of the above additional values, the priority score calculated for the possible combination “#3” of the buildings to be recovered is updated to “40,300” by adding the score “10,100” calculated when the “service II priority policy” is applied as the second application order to the score “30,200” calculated when the “service III priority policy” is applied as the first application order (see the reference sign e in FIG. 13).

Then, the combinations are sorted again in order of the priority score calculated for each combination, and the identification number of a combination having the smallest priority score, that is, the identification number of a combination having the lowest priority of the actual restoration work is specified to be “#4” (see the reference sign f in FIG. 13).

The identification number of a combination having the second smallest priority score is “#1”, the identification number of a combination having the third smallest priority score is “#3”, and the identification number of a combination having the largest priority score, that is, the identification number of a combination having the highest priority of the actual restoration work is “#2” (see the reference signs c to e in FIG. 13).

As described above, the scores calculated by applying the “service II priority policy” are added to the patterns whose priority scores are the same only when the “service III priority policy” is applied, and thus the priority scores can be made different. Therefore, a difference in the priority of the actual restoration work becomes clear, which makes it possible to clarify the priority of the actual restoration work.

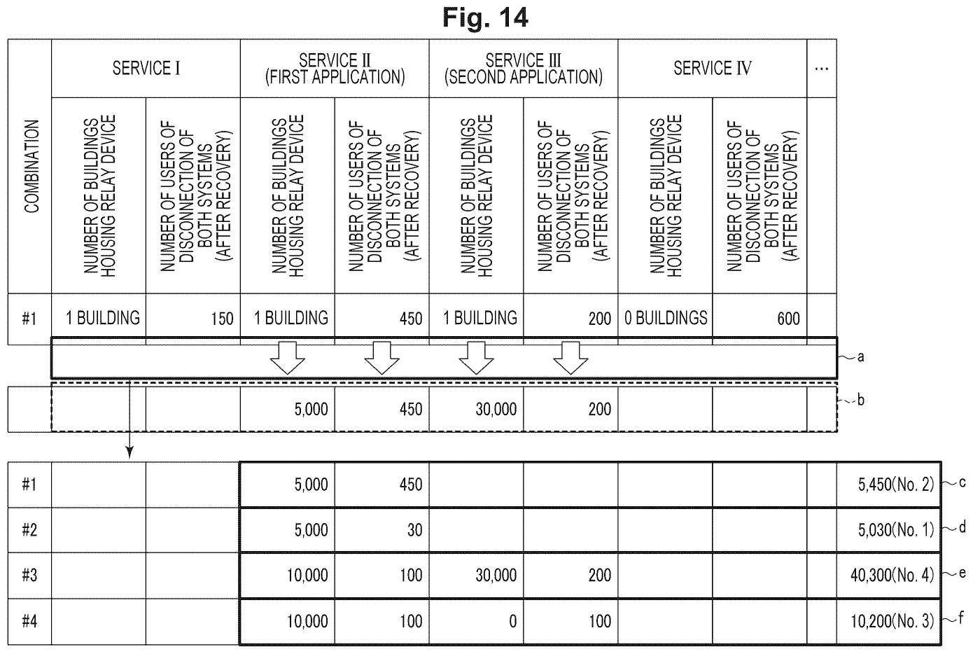

FIG. 14 illustrates an example of priority scores calculated by sequentially applying the second policy and the first policy under a condition that a restoration work has been performed on a combination of buildings serving as a target of the restoration work.

In the example of FIG. 14, application orders of the plurality of kinds of policies are reversed as compared with the example of FIG. 13. That is, the “service II priority policy” described with reference to FIG. 7 is applied as the first application order (see a reference sign a in FIG. 14). Then, when priority scores calculated by applying the “service II priority policy” are the same in some of the patterns of the combinations, the “service III priority policy” is applied only for this pattern as the second application order to the situation in which the “service III relay building” in which the communication failure regarding the “service III” continuously occurs is present (see the reference sign a in FIG. 14). Then, the priority scores calculated by the above application are calculated as additional values of the priority scores regarding the corresponding patterns (see a reference sign b in FIG. 14). This improves clarity of the priority of the restoration work when the patterns are sorted.

Specifically, for each of the combinations “#1” and “#4” of the buildings to be recovered in FIG. 7, the “service II priority policy” is applied as the first application order, and thus priority scores are calculated (see reference signs c to f in FIG. 14).

As a result of sorting the combinations in order of the priority score calculated for each combination, as illustrated in FIG. 7, the priority scores, which are obtained by adding the score regarding the penalty and the score regarding the users of both the systems calculated for each of the combinations “#3” and “#4” of the buildings to be recovered, are the same “10,100” (see the reference signs e and f in FIG. 14).

In view of this, for each of the combinations “#3” and “#4”, a priority score is calculated by applying the “service III priority policy” as the second application order to the situation in which the “service III relay building” in which the communication failure regarding the “service III” occurs is present.

As a result of the calculation, as illustrated in FIG. 14, the additional value of the priority score, which is obtained by adding the score regarding the penalty and the score regarding the users of both the systems calculated for the possible combination “#3” of the buildings to be recovered, is “30,200” (see the reference sign e in FIG. 14). Further, the additional value of the priority score, which is obtained by adding the score regarding the penalty and the score regarding the users of both the systems calculated for the possible combination “#4” of the buildings to be recovered, is “100” (see the reference sign f in FIG. 14).

As a result of the calculation of the above additional values, the priority score calculated for the possible combination “#3” of the buildings to be recovered is updated to “40,300” by adding the score “30,200” calculated when the “service III priority policy” is applied as the second application order to the score “10,100” calculated when the “service II priority policy” is applied as the first application order (see the reference sign e in FIG. 14).

As a result of the calculation of the above additional values, the priority score calculated for the possible combination “#4” of the buildings to be recovered is updated to “10,200” by adding the score “100” calculated when the “service III priority policy” is applied as the second application order to the score “10,100” calculated when the “service II priority policy” is applied as the first application order (see the reference sign f in FIG. 14).

Then, the combinations are sorted again in order of the priority score calculated for each combination, and the identification number of a combination having the smallest priority score, that is, the identification number of a combination having the lowest priority of the actual restoration work is specified to be “#2” (see the reference sign d in FIG. 14).

The identification number of a combination having the second smallest priority score is “#1”, the identification number of a combination having the third smallest priority score is “#4”, and the identification number of a combination having the largest priority score, that is, the identification number of a combination having the highest priority of the actual restoration work is “#3” (see the reference signs c, e, and f in FIG. 14).

As described above, the scores calculated by applying the “service III priority policy” are added to the patterns whose priority scores are the same only when the “service II priority policy” is applied, and thus the priority scores can be made different. Therefore, a difference in the priority of the actual restoration work becomes clear, which makes it possible to clarify the priority of the actual restoration work.

As described above, in the network management device according to the embodiment of the present invention, a policy, which defines weighting corresponding to a situation in which, when a failure in communication occurs in a plurality of buildings that houses a communication facility and when a condition in which the failure that occurred is assumed to be restored in some buildings among the plurality of buildings in which the failure has occurred by performing a restoration work on the communication facility housed in combinations of the buildings is applied, the failure in communication continuously occurs in a building that houses a communication facility used for providing a predetermined type of communication service, is applied to the situation, and thus a score regarding priority of a possible building in which the failure that occurred is to be actually restored among the buildings in the upper layer is calculated for each of the plurality of combinations.

Therefore, it is possible to appropriately specify a target to be restored from a communication failure when the communication failure occurs in a network configuration.

For example, in a general method, priority of a building to be recovered is artificially given according to a situation of a failure occurring in a network on the basis of an empirical rule of a skilled person. However, when the above method is used, it is difficult to understand a background of determination regarding the giving of the priority, and it is also difficult to understand based on what kind of idea the target to be restored is specified.

Meanwhile, in the present embodiment, the priority of a building to be restored is calculated by using a policy that defines weighting based on a situation of a failure that continuously occurs when the building is assumed to be restored.

Therefore, even if the operator does not have advanced skills, the priority of the building to be restored can be appropriately specified by setting a communication service to be preferentially provided.

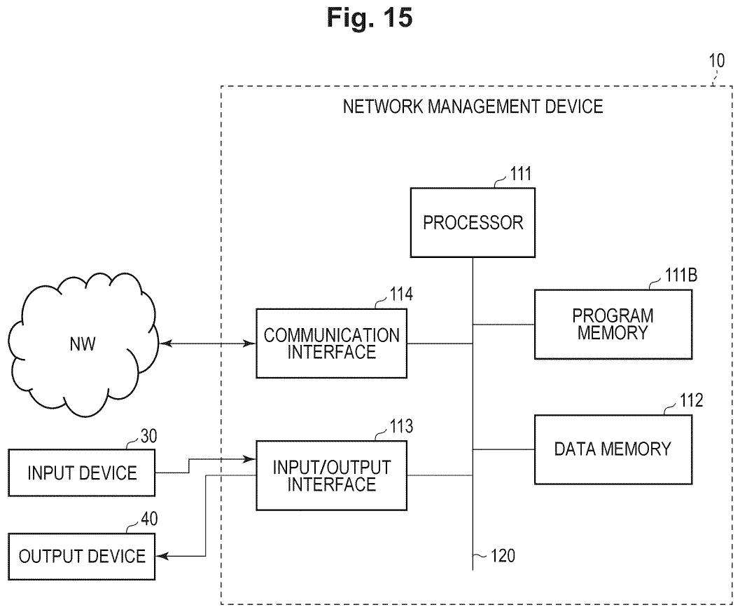

FIG. 15 is a block diagram illustrating an example of a hardware configuration of the network management device according to the embodiment of the present invention.

In the example of FIG. 15, the network management device 10 according to the embodiment described above is, for example, a server computer or a personal computer and includes a hardware processor 111A such as a CPU. The hardware processor 111A is connected to a program memory 111B, a data memory 112, an input/output interface 113, and a communication interface 114 via a bus 120.

The communication interface 114 includes, for example, one or more wireless communication interface units and enables transmission and reception of information to and from a communication network NW. The wireless interface is, for example, an interface in which a low-power wireless data communication standard such as a wireless local area network (LAN) is adopted.

The input/output interface 113 is connected to an input device 30 and an output device 40 that are attached to the network management device 10 and are used by a user or the like.

The input/output interface 113 can perform processing of fetching operation data input by the user or the like through the input device 30 such as a keyboard, a touchscreen, a touchpad, or a mouse and outputting output data to the output device 40 including a display device made from liquid crystal, organic electro-luminescence (EL), or the like, thereby displaying the output data thereon. The input device 30 and the output device 40 may be a device included in the network management device 10 or may be an input device and an output device of another information terminal that can communicate with the network management device 10 via the network NW.

The program memory 111B is used as a non-transitory tangible storage medium by combining, for example, a non-volatile memory enabling writing and reading at any time, such as a hard disk drive (HDD) or a solid state drive (SSD), and a non-volatile memory such as read only memory (ROM) and can store programs necessary for executing various types of control processing according to the embodiment.

The data memory 112 is used as a tangible storage medium, for example, by combining the non-volatile memory described above and a volatile memory such as random access memory (RAM) and can be used to store various types of data or information acquired and created in a process of performing various types of processing.

The network management device 10 according to the embodiment of the present invention can be configured as a data processing device including the user input unit 11, the failure influence calculation unit 12, the priority calculation unit 13, the deployment plan processing unit 14, and the deployment plan output unit 15 in FIG. 1 as processing function units by software.

Information storage units used as work memories or the like by the respective units of the network management device 10 can be configured by using the data memory 112 in FIG. 15. However, those configured storage areas are not essential configurations in the network management device 10 and may be provided in, for example, an external storage medium such as a universal serial bus (USB) memory or a storage device such as a database server arranged in a cloud.

All the processing function units of the user input unit 11, the failure influence calculation unit 12, the priority calculation unit 13, the deployment plan processing unit 14, and the deployment plan output unit 15 can be implemented by causing the hardware processor 111A to read and execute the program stored in the program memory 111B. Note that some or all of the processing function units may be implemented in other various forms including an integrated circuit such as an application specific integrated circuit (ASIC) or a field-programmable gate array (FPGA).

Further, the methods described in the embodiments can be stored in a recording medium such as a magnetic disk (e.g. Floppy (registered trademark) disk and hard disk), an optical disc (e.g. CD-ROM, DVD, and MO), or a semiconductor memory (e.g. ROM, RAM, and flash memory) as a program (software means) that can be executed by a computer and can also be distributed by being transmitted through a communication medium. The programs stored in the medium also include a setting program for configuring, in the computer, software means (including not only an execution program but also tables and data structures) to be executed by the computer. The computer that implements the present device executes the above-described processing by reading the programs recorded in the recording medium, constructing the software means by the setting program as needed, and controlling operation by the software means. The recording medium described in the present specification is not limited to a recording medium for distribution, but includes a storage medium such as a magnetic disk or a semiconductor memory provided in the computer or in a device connected via a network.

The present invention is not limited to the above embodiments, and various modifications can be made in the implementation stage without departing from the gist of the invention. The embodiments may be implemented in combination, and, in that case, combined effects can be obtained. Further, the embodiments described above include various inventions, and various inventions can be extracted by a combination selected on the basis of a plurality of disclosed components. For example, even if some components are eliminated from all the components described in the embodiment, a configuration from which the components are eliminated can be extracted as an invention in a case where the configuration can solve the problem and have advantageous effects.

### REFERENCE SIGNS LIST

10 Network management device
11 User input unit
12 Failure influence calculation unit
13 Priority calculation unit
14 Deployment plan processing unit
15 Deployment plan output unit

1. A network management device, comprising:
priority calculation circuitry configured to apply, to a situation in which, when a failure in communication occurs in a plurality of buildings that houses a communication facility and when a condition in which the failure that occurred is assumed to be restored in each building regarding a plurality of combinations of some buildings among the buildings in which the failure has occurred by performing a restoration work on the communication facility housed in the building is applied, the failure in communication continuously occurs in a building that houses a communication facility used for providing a predetermined type of communication service among the plurality of buildings, a policy that defines weighting corresponding to the situation, and to calculate, for each of the plurality of combinations, priority of a possible combination of buildings in which the failure that occurred is to be actually restored among the buildings in which the failure has occurred.

2. The network management device according to claim 1, wherein:
the policy includes a first policy that defines weighting corresponding to the situation of the failure in communication continuously occurring in a building that houses a communication facility used for providing a first type of communication service among the buildings in which the failure has occurred when the assumed condition is applied and a second policy that defines weighting corresponding to the situation of the failure in communication continuously occurring in a building that houses a communication facility used for providing a second type of communication service among the buildings in which the failure has occurred when the assumed condition is applied; and
the priority calculation circuitry calculates, for each of the plurality of combinations, a score regarding the priority of a possible building in which the failure that occurred is to be actually restored among the buildings in which the failure has occurred by applying the first policy to the situation of the failure in communication continuously occurring in the building that houses the communication facility used for providing the first type of communication service among the buildings in which the failure has occurred when the assumed condition is applied, and
when scores calculated for the plurality of combinations are same as a result of the calculation and when the assumed condition is applied to the combinations, calculates, for each of the plurality of combinations having the same score among the plurality of combinations, a score regarding the priority of the possible building in which the failure that occurred is to be actually restored among the buildings in which the failure has occurred by applying the second policy to the situation of the failure in communication continuously occurring in the building that houses the communication facility used for providing the second type of communication service among the buildings in which the failure has occurred, and thus calculates, for each of the plurality of combinations, the priority of the possible combination of the buildings in which the failure that occurred is to be actually restored among the buildings in which the failure has occurred.

3. The network management device according to claim 1, wherein:
the situation of the failure in communication continuously occurring in the building that houses the communication facility used for providing the predetermined type of communication service includes
the number of buildings regarding the continuously occurring failure in communication when the assumed condition is applied and the number of users who are housed in the buildings and use the predetermined type of communication service.

4. The network management device according to claim 1, further comprising:
a plan processing circuitry configured to plan an actual restoration work from the failure that occurred on the basis of a condition regarding the restoration work of the failure with respect to the building corresponding to the priority calculated by the priority calculation circuitry.

5. The network management device according to claim 4, wherein:
the plan processing circuitry prioritizes a building having higher priority calculated by the priority calculation circuitry and plans a vehicle to be actually deployed to the building and a movement route of the vehicle to the building on the basis of information regarding the failure in the building and information regarding a possible vehicle deployed for the restoration work of the failure in the building.

6. A method, comprising:
applying, to a situation in which, when a failure in communication occurs in a plurality of buildings that houses a communication facility and when a condition in which the failure that occurred is assumed to be restored in each building regarding a plurality of combinations of some buildings among the buildings in which the failure has occurred by performing a restoration work on the communication facility housed in the building is applied, the failure in communication continuously occurs in a building that houses a communication facility used for providing a predetermined type of communication service among the plurality of buildings, a policy that defines weighting corresponding to the situation and calculating, for each of the plurality of combinations, priority of a possible combination of buildings in which the failure that occurred is to be actually restored among the buildings in which the failure has occurred.

7. The network management method according to claim 6, wherein:
the policy includes a first policy that defines weighting corresponding to the situation of the failure in communication continuously occurring in a building that houses a communication facility used for providing a first type of communication service among the buildings in which the failure has occurred when the assumed condition is applied and a second policy that defines weighting corresponding to the situation of the failure in communication continuously occurring in a building that houses a communication facility used for providing a second type of communication service among the buildings in which the failure has occurred when the assumed condition is applied; and
calculating the priority includes calculating, for each of the plurality of combinations, a score regarding the priority of a possible building in which the failure that occurred is to be actually restored among the buildings in which the failure has occurred by applying the first policy to the situation of the failure in communication continuously occurring in the building that houses the communication facility used for providing the first type of communication service among the buildings in which the failure has occurred when the assumed condition is applied, and
when scores calculated for the plurality of combinations are same as a result of the calculation and when the assumed condition is applied to the combinations, calculating, for each of the plurality of combinations having the same score among the plurality of combinations, a score regarding the priority of the possible building in which the failure that occurred is to be actually restored among the buildings in which the failure has occurred by applying the second policy to the situation of the failure in communication continuously occurring in the building that houses the communication facility used for providing the second type of communication service among the buildings in which the failure has occurred, and thus calculating, for each of the plurality of combinations, the priority of the possible combination of the buildings in which the failure that occurred is to be actually restored among the buildings in which the failure has occurred.

8. A non-transitory computer readable medium storing a network management processing program for causing a processor to function as each of the circuitries of the network management device according to claim 1.

9. A non-transitory computer readable medium storing a network management processing program for causing a processor to perform the method of claim 6.
